(19) United States
(12) Patent Application Publication
(10) Pub. No.: US 2019/0074535 A1
(43) Pub. Date: Mar. 7, 2019

(54) SECONDARY BATTERY

(71) Applicant: Murata Manufacturing Co., Ltd., Nagaokakyo-shi (JP)

(72) Inventors: Toru Kawai, Nagaokakyo-shi (JP); Masahiro Otsuka, Nagaokakyo-shi (JP)

(21) Appl. No.: 16/184,104

(22) Filed: Nov. 8, 2018

Related U.S. Application Data
(63) Continuation of application No. PCT/JP2017/007338, filed on Feb. 27, 2017.

(30) Foreign Application Priority Data
May 31, 2016 (JP) 2016-109183

(51) Int. Cl. H01M 10/04

(52) U.S. Cl. CPC H01M 10/0431

(57) ABSTRACT

A secondary battery that an electrode assembly formed by stacking electrode-constituting layers each including a positive electrode, a negative electrode, and a separator between the positive electrode and the negative electrode. The electrode assembly has at least two sub-electrode bodies respectively formed of wound portions, non-wound portions, or a wound portion and a non-wound portion. The sub-electrode bodies are joined by a mutually shared electrode-constituting layer, and the shared electrode-constituting layer is a bent portion.

### CROSS REFERENCE TO RELATED APPLICATIONS

The present application is a continuation of International application No. PCT/JP2017/007338, filed Feb. 27, 2017, which claims priority to Japanese Patent Application No. 2016-109183, filed May 31, 2016, the entire contents of each of which are incorporated herein by reference.

### FIELD OF THE INVENTION

The present invention relates to a secondary battery. Particularly, it relates to a secondary battery including an electrode assembly formed by stacking electrode-constituting layers including a positive electrode, a negative electrode, and a separator.

### BACKGROUND OF THE INVENTION

A secondary battery can be repeatedly charged and discharged because the secondary battery is a so-called “storage battery”, and is used for various applications. For example, the secondary battery is used for mobile devices such as mobile phones, smart phones and laptop computers.

For various applications including mobile devices and the like, the secondary battery is generally accommodated within a housing of the mobile device and the like.

Patent Document 1: Japanese Patent Application National Publication (Laid-Open) No. 2015-536036

### SUMMARY OF THE INVENTION

The present inventors have noticed that there is a problem to be overcome in conventional secondary batteries and have arrived at a solution to the problem. Specifically, the present inventors have found that there is the following problem.

It is necessary to consider the balance of the installation space of the secondary battery in the housing with other device elements such as a circuit board and various parts. Particularly, with recent diversification of needs, there is a tendency that the installation space of the secondary battery is more restricted by the housing and various elements accommodated in the housing, whereby the shape of the conventional secondary battery is not sufficient to fit within the restricted space.

The present invention has been made in view of the above problem. That is, a main object of the present invention is to provide a secondary battery having a higher degree of freedom in shape.

The present inventors have attempted to solve the above problem by coming at it from a new direction rather than coming at it as an extension of the conventional technology. As a result, the invention of the secondary battery has been completed in which the above-described main object is achieved.

The secondary battery according to an aspect of the present invention includes an electrode assembly formed by stacking electrode-constituting layers each including a positive electrode, a negative electrode, and a separator between the positive electrode and the negative electrode. The electrode assembly has at least two sub-electrode bodies respectively formed of wound portions, non-wound portions, or a wound portion and a non-wound portion, the wound portion being a portion in which at least one electrode-constituting layer is in a wound form, the non-wound portion being a portion in which at least one electrode-constituting layer is arranged in a planar form without being wound. The sub-electrode bodies are joined by a mutually shared electrode-constituting layer, and the shared electrode-constituting layer is a bent portion.

The secondary battery according to an aspect of the present invention has a higher degree of freedom in shape. That is, the secondary battery can have a more suitable shape for various battery installation spaces.

### BRIEF EXPLANATION OF THE DRAWINGS

FIGS. 1(A) and 1(B) are cross-sectional views schematically showing electrode-constituting layers (FIG. 1(A): a non-wound portion of the electrode-constituting layer, FIG. 1(B): a wound portion of the electrode-constituting layer).

FIG. 2 is a cross-sectional view schematically showing a configuration of an electrode assembly according to an embodiment of the present invention (a combination of a wound portion and a non-wound portion).

FIG. 3 is a cross-sectional view schematically showing a configuration of an electrode assembly according to an embodiment of the present invention (a combination of wound portions).

FIG. 4 is a cross-sectional view schematically showing a configuration of an electrode assembly according to an embodiment of the present invention (a combination of non-wound portions).

FIGS. 5(A) to (C) are cross-sectional views schematically showing forms of rigid batteries (FIG. 5(A): a combination of a wound portion and a non-wound portion, FIG. 5(B): a combination of wound portions, FIG. 5(C): combination of non-wound portions).

FIG. 6 is a cross-sectional view schematically showing a form of a flexible battery (time-dependent change in bending displacement).

FIGS. 7(A) and 7(B) are perspective views schematically showing forms of sub-electrode bodies having different extending lengths (FIG. 7(A): rigid battery, FIG. 7 (B): flexible battery).

FIGS. 8(A) and 8(B) are cross-sectional views schematically showing electrode assemblies having “at least two bent portions” (FIG. 8(A): a combination of one wound portion and two non-wound portions, FIG. 8(B): a combination of two wound portions and one non-wound portion).

FIG. 9 is a schematic diagram for explaining “a non-rectangular shape” or “an irregular shape”.

### DETAILED DESCRIPTION OF THE INVENTION

Hereinafter, a secondary battery according to an embodiment of the present invention will be described in more detail. Although the secondary battery will be explained, if necessary, with reference to the drawings, various elements in the drawings are merely shown schematically and exemplarily for the understanding of the present invention, and the appearance, the dimensional ratio, and the like can be different from an actual secondary battery.

The “thickness” direction described directly or indirectly in this specification is based on the stacking direction of electrode materials constituting the secondary battery, that is, the “thickness” corresponds to the dimension in the stacking direction of the positive and negative electrodes.

Further, the term “in planar view” used in the present specification is based on a sketch drawing when an object is viewed from the upper side or the lower side along a direction of the above thickness, and the term “cross-sectional view (or in sectional view)” is based on an imaginary cross section of an object obtained by cutting along the thickness direction of the secondary battery. Further, the term “in side view” is based on a sketch drawing of an object viewed from a direction in which the thickness of an object (e.g., the thickness of a secondary battery or an electrode assembly) can be captured.

The terms “vertical direction” and “horizontal direction” used directly or indirectly in the present specification respectively correspond to the vertical direction and the horizontal direction in the drawings. Unless otherwise specified, the same reference symbols or symbols shall denote the same members or the same semantic contents.

[Configuration of Secondary Battery of Present Invention]

According to the present invention, there is provided a secondary battery. The term “secondary battery” in the present specification means a battery that can be repeatedly charged and discharged. Therefore, the secondary battery of the present invention is not excessively limited by its name, and for example, “an electric storage device” and the like can be included in the subject of the present invention.

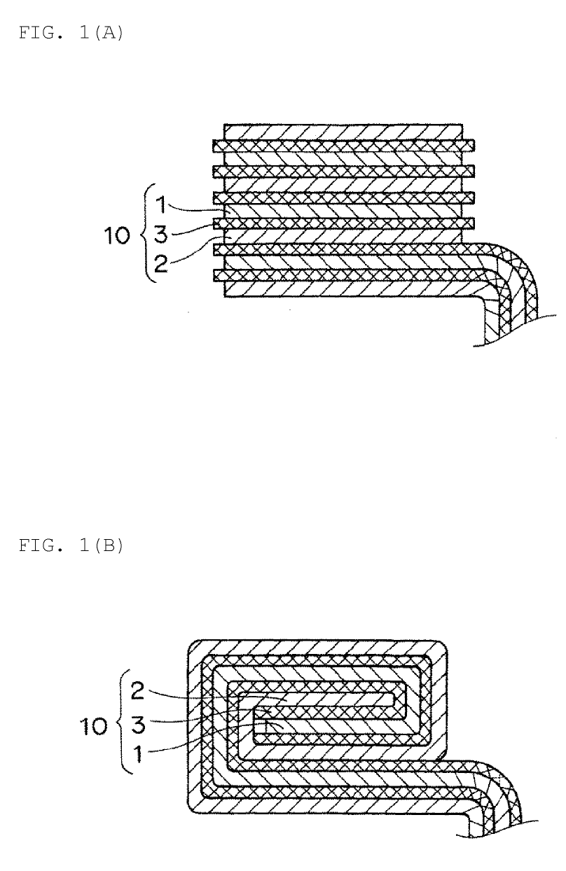

The secondary battery according to the present invention includes an electrode assembly formed by stacking electrode-constituting layers including a positive electrode, a negative electrode, and a separator. As shown in FIGS. 1(A) and 1(B), a positive electrode 1 and a negative electrode 2 are stacked with a separator 3 interposed therebetween to form an electrode-constituting layer 10, and an electrode assembly formed by stacking at least one or more of the electrode-constituting layers 10 is enclosed in an exterior body together with an electrolyte.

The positive electrode is composed of at least a positive electrode material layer and a positive electrode current collector. In the positive electrode, a positive electrode material layer is provided on at least one side of the positive electrode current collector, and the positive electrode material layer contains a positive electrode active material as an electrode active material. For example, in a plurality of the positive electrodes in the electrode assembly, the positive electrode material layer may be provided on both sides of the positive electrode current collector, or may be provided only on one side of the positive electrode current collector. From the viewpoint of further increasing the capacity of the secondary battery, it is preferable that the positive electrode includes the positive electrode material layers provided on both sides of the positive electrode current collector.

The negative electrode is composed of at least a negative electrode material layer and a negative electrode current collector. In the negative electrode, a negative electrode material layer is provided on at least one side of the negative electrode current collector, and the negative electrode material layer contains a negative electrode active material as an electrode active material. For example, in a plurality of the negative electrodes in the electrode assembly, the negative electrode material layer may be provided on both sides of the negative electrode current collector, or may be provided only on one side of the negative electrode current collector. From the viewpoint of further increasing the capacity of the secondary battery, it is preferable that the negative electrode includes the negative electrode material layers provided on both sides of the negative electrode current collector.

The electrode active material contained in the positive electrode and the negative electrode, i.e., the positive and negative electrode active materials are substances directly involved in the transfer of electrons in the secondary battery and are main substances of the positive and negative electrodes which are responsible for charging and discharging, namely a battery reaction. More specifically, ions are generated in the electrolyte by “the positive electrode active material contained in the positive electrode material layer” and “the negative electrode active material contained in the negative electrode material layer”, and the ions move between the positive electrode and the negative electrode and the electrons are transferred, whereby charging and discharging are performed. It is preferable that the positive and negative electrode material layers are particularly layers capable of occluding and releasing lithium ions. In other words, the secondary battery according to the present invention is preferably a nonaqueous electrolyte secondary battery in which lithium ions move between a positive electrode and a negative electrode through a nonaqueous electrolyte, to charge and discharge the battery. In the case where lithium ions are involved in charging and discharging, the secondary battery according to the present invention corresponds to a so-called “lithium ion battery”, and the positive electrode and the negative electrode have a layer capable of occluding and releasing lithium ions.

The positive electrode active material of the positive electrode material layer is made of, for example, a granular material, and it is preferable that a binder (also referred to as “binding material”) is contained in the positive electrode material layer in order to maintain a sufficient contact between particles and the shape of the particles. Further, a conductive auxiliary agent may be contained in the positive electrode material layer in order to facilitate transmission of electrons promoting the battery reaction. Similarly, when the negative electrode active material of the negative electrode material layer is made of, for example, a granular material, a binder is preferably contained in order to maintain a sufficient contact between particles and the shape of the particles, and a conductive auxiliary agent may be contained in the negative electrode material layer in order to facilitate transmission of electrons promoting the battery reaction. As described above, since a plurality of components is contained, the positive electrode material layer and the negative electrode material layer can also be referred to as “positive electrode mixture layer” and “negative electrode mixture layer”, respectively.

It is preferable that the positive electrode active material is a material contributing to occlusion and release of lithium ions. From these points of view, it is preferable that the positive electrode active material is, for example, a lithium-containing composite oxide. More specifically, it is preferable that the positive electrode active material is a lithium transition metal composite oxide which contains lithium and at least one transition metal selected from the group consisting of cobalt, nickel, manganese, and iron. That is, in the positive electrode material layer of the secondary battery according to the present invention, the lithium transition metal composite oxide is preferably contained as the positive electrode active material. Examples of the positive electrode active material may include lithium cobaltate, lithium nickelate, lithium manganate, lithium iron phosphate, or materials in which a part of the transition metal of these is substituted with another metal. Although the positive electrode active material may be contained singly or two or more kinds thereof may be contained. Although it is merely an example, in the secondary battery according to the present invention, the positive electrode active material contained in the positive electrode material layer may be lithium cobaltate.

The binder which can be contained in the positive electrode material layer is not particularly limited, but examples thereof include at least one selected from the group consisting of polyvinylidene fluoride, a vinylidene fluoride-hexafluoropropylene copolymer, a vinylidene fluoride-tetrafluoroethylene copolymer, and polytetrafluoroethylene. The conductive auxiliary agent which can be contained in the positive electrode material layer is not particularly limited, but examples thereof include at least one selected from the group consisting of carbon black such as thermal black, furnace black, channel black, ketjen black, and acetylene black; carbon fibers such as graphite, carbon nanotube, and vapor-grown carbon fiber; metal powders such as copper, nickel, aluminum, and silver; and polyphenylene derivatives. For example, the binder of the positive electrode material layer may be polyvinylidene fluoride, and the conductive auxiliary agent of the positive electrode material layer may be carbon black. Although it is merely an example, the binder and the conductive auxiliary agent in the positive electrode material layer may be a combination of polyvinylidene fluoride and carbon black.

It is preferable that the negative electrode active material is a material contributing to occlusion and release of lithium ions. From these points of view, as the negative electrode active material, for example, various carbon materials, oxides, or lithium alloys are preferred.

Examples of the various carbon materials for the negative electrode active material include graphite (natural graphite and artificial graphite), hard carbon, soft carbon, and diamond-like carbon. Particularly, graphite is preferred because it has high electron conductivity and excellent adhesion to the negative electrode current collector and the like. Examples of the oxide of the negative electrode active material include at least one selected from the group consisting of silicon oxide, tin oxide, indium oxide, zinc oxide, and lithium oxide. The lithium alloy of the negative electrode active material may be any metal as long as the metal can be alloyed with lithium, and the lithium alloy may be, for example a binary, ternary or higher alloy of a metal such as Al, Si, Pb, Sn, In, Bi, Ag, Ba, Ca, Hg, Pd, Pt, Te, Zn or La and lithium. It is preferable that the structural form of the oxide is amorphous. This is because degradation due to nonuniformity such as grain boundaries or defects is unlikely to be caused. Although it is merely an example, in the secondary battery according to the present invention, the negative electrode active material of the negative electrode material layer may be artificial graphite.

The binder which can be contained in the negative electrode material layer is not particularly limited, but examples thereof include at least one kind selected from the group consisting of styrene-butadiene rubber, polyacrylic acid, polyvinylidene fluoride, polyimide-based resin, and polyamideimide-based resin. For example, the binder contained in the negative electrode material layer may be a styrene-butadiene rubber. The conductive auxiliary agent which can be contained in the negative electrode material layer is not particularly limited, but examples thereof include at least one selected from the group consisting of carbon black such as thermal black, furnace black, channel black, ketjen black, and acetylene black; carbon fibers such as graphite, carbon nanotube, and vapor-grown carbon fiber; metal powders such as copper, nickel, aluminum, and silver; and polyphenylene derivatives. It is to be noted that the negative electrode material layer may contain a component caused by a thickener component (e.g., carboxymethyl cellulose) used at the time of producing the battery.

Although it is merely an example, the negative electrode active material and the binder in the negative electrode material layer may be a combination of artificial graphite and styrene-butadiene rubber.

The positive electrode current collector and the negative electrode current collector used for the positive electrode and the negative electrode are members that contribute to the collection and supply of electrons generated in the active material by the battery reaction. Each of the current collectors may be a sheet-like metal member and may have a porous or perforated form. For example, each of the current collectors may be a metal foil, a punching metal, a net, an expanded metal, or the like. The positive electrode current collector used for the positive electrode is preferably made of a metal foil containing at least one selected from the group consisting of aluminum, stainless steel, and nickel, and may be, for example, an aluminum foil. On the other hand, the negative electrode current collector used for the negative electrode is preferably made of a metal foil containing at least one selected from the group consisting of copper, stainless steel, and nickel, and may be, for example, a copper foil.

The separator used for the positive electrode and the negative electrode is a member provided from the viewpoints of the prevention of short circuit due to contact between the positive and negative electrodes and the holding of the electrolyte and the like. In other words, it can be said that the separator is a member that passes ions while preventing electronic contact between the positive and negative electrodes. Preferably, the separator is a porous or microporous insulating member and has a film form due to its small thickness. Although it is merely an example, a microporous membrane made of polyolefin may be used as the separator. In this respect, the microporous membrane used as the separator may contain, for example, only polyethylene (PE) or only polyethylene (PP) as polyolefin. Further, the separator may be a stacked body composed of “a microporous membrane made of PE” and “a microporous membrane made of PP”. The surface of the separator may be covered with an inorganic particle coating layer, an adhesive layer, or the like. The surface of the separator may have adhesive properties. It is to be noted that, in the present invention, the separator should not be limited, particularly by its name, and may be a solid electrolyte, a gel electrolyte, an insulating inorganic particle or the like, which have a similar function.

In the secondary battery of the present invention, an electrode assembly composed of an electrode-constituting layer including a positive electrode, a negative electrode, and a separator is enclosed in an exterior body together with an electrolyte. When the positive electrode and the negative electrode have a layer capable of occluding and releasing lithium ions, the electrolyte is preferably a “nonaqueous-based” electrolyte such as an organic electrolyte or an organic solvent (i.e., the electrolyte is preferably a nonaqueous electrolyte). In the electrolyte, metal ions released from electrodes (positive and negative electrodes) are present, and thus the electrolyte helps the transfer of metal ions in the battery reaction.

The nonaqueous electrolyte is an electrolyte containing a solvent and a solute. As a specific solvent for the nonaqueous electrolyte, a solvent containing at least a carbonate is preferred. The carbonates may be cyclic carbonates and/or chain carbonates. Although not particularly limited, examples of the cyclic carbonates include at least one kind selected from the group consisting of propylene carbonate (PC), ethylene carbonate (EC), butylene carbonate (BC), and vinylene carbonate (VC). Examples of the chain carbonates include at least one kind selected from the group consisting of dimethyl carbonate (DMC), diethyl carbonate (DEC), ethyl methyl carbonate (EMC), and dipropyl carbonate (DPC). Although it is merely an example, a combination of cyclic carbonate and chain carbonate may be used as the nonaqueous electrolyte, and, for example, a mixture of ethylene carbonate and diethyl carbonate may be used. As a solute of a specific nonaqueous electrolyte, for example, an Li salt such as LiPF₆ and/or LiBF₄ is preferably used.

[Characteristics of Secondary Battery According to an Aspect of the Present Invention]

The secondary battery according to an aspect of the present invention has characteristics in the three-dimensional structure of the electrode assembly. Specifically, the electrode assembly of the secondary battery according to an embodiment of the present invention has at least two sub-electrode bodies respectively formed of “wound portions each being a portion in which at least one electrode-constituting layer is wound in a wound form” and “non-wound portions each being a portion in which at least one electrode-constituting layer is arranged in a planar form without being wound”, or the wound portion and the non-wound portion. Particularly, in the electrode assembly, the sub-electrode bodies are continuously connected by a mutually shared electrode-constituting layer, and the shared electrode-constituting layer forms a bent portion.

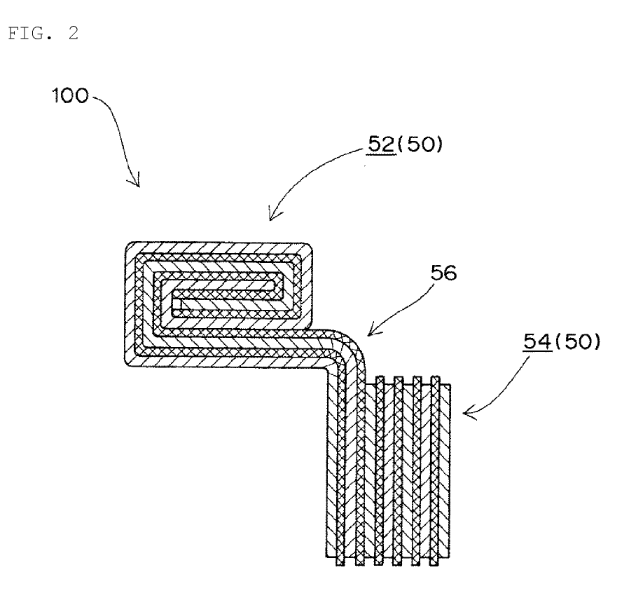

FIGS. 2 to 4 show a three-dimensional structure of an electrode assembly 100 according to an embodiment of the present invention. As can be seen from the illustrated form, the electrode assembly 100 includes “a wound portion 52” and/or “a non-wound portion 54” which are arranged side by side so as to form a pair of sub-electrode bodies 50, and the sub-electrode bodies are provided so as to form an angle with each other. The angle is formed in this manner, whereby a higher degree of freedom is provided to the three-dimensional shape of the electrode assembly 100. More specifically, when the whole of the secondary battery of the present invention is captured in the thickness direction, the electrode assembly 100 has a form of being locally displaced or a form of being displaced (in other words, in the secondary battery of the present invention, a part of the electrode assembly has a bent shape, or can be bent in such a manner).

The term “sub-electrode body” in the present specification refers to a member constituting the electrode assembly, and particularly refers to a member which constitutes the electrode assembly of the secondary battery by forming a part of the electrode assembly and combining with a separate electrode body. Hence, “the sub-electrode body” of the present invention corresponds to an electrode stacked body including at least a stacked configuration including a positive electrode, a negative electrode, and a separator, and the presence of a separate electrode stacked body which similarly has the stacked configuration is implicitly contemplated.

For example, in FIG. 2, the sub-electrode body 50 includes “the wound portion 52” and “the non-wound portion 54”, which are joined by “a mutually shared electrode-constituting layer 56 (in the present specification, the electrode-constituting layer 56 is also referred to as particularly “shared electrode-constituting layer”). As can be seen from the illustrated form, the shared electrode-constituting layer 56 forms a bent portion of the electrode assembly 100, i.e., a bent portion of the secondary battery. When viewed from another perspective, it can be said that, in the electrode assembly 100 shown in FIG. 2, the non-wound portion 54 is provided on an extension portion extending from the wound portion 52 and forming the bent portion.

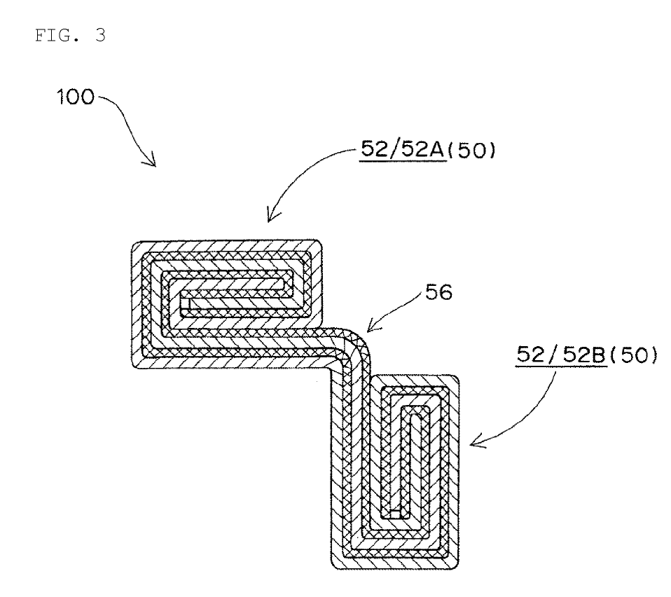

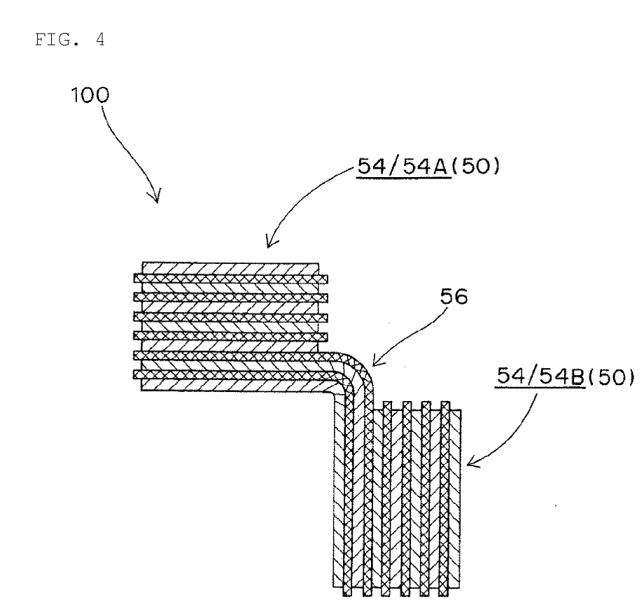

In the electrode assembly 100 shown in FIG. 3, only two of “the wound portions 52” are included as the sub-electrode bodies 50, and the wound portions (52A and 52B) are connected by the shared electrode-constituting layer 56 which forms a bent portion. In other words, the wound portions are connected to each other with the bent portion of the shared electrode-constituting layer interposed therebetween. When viewed from another perspective, it can be said that, in the electrode assembly 100 shown in FIG. 3, on an extension portion extending from one wound portion and forming a bent portion, the other wound portion is provided. It is to be noted that, one non-wound portion 52A and the other non-wound portion 52B preferably have a relationship in which their winding axes are substantially parallel to each other. In the electrode assembly 100 shown in FIG. 4, only two of “the non-wound portions 54” are included as the sub-electrode bodies 50, and the non-wound portions (54A and 54B) are connected by the shared electrode-constituting layer 56 which forms a bent portion. In other words, the non-wound portions are connected to each other with the bent portion of the shared electrode-constituting layer interposed therebetween. Similarly, when viewed from another perspective, in the electrode assembly 100 shown in FIG. 4, on an extension portion extending from one non-wound portion and forming a bent portion, the other non-wound portion is provided.

Particularly, in the case of including only the “wound portions 52” as shown in FIG. 3, current can be collected from one place, thereby providing a secondary battery which is more preferable from the viewpoint of energy density.

As can be seen from the forms shown in FIGS. 2 to 4, in the present invention, an electrode-constituting layer of one sub-electrode body 50 is extended and protruded so as to be curved or bent outward, the extended and protruded layer forms an electrode-constituting layer of the other sub-electrode body 50, and vice versa (in other words, an electrode-constituting layer of the other sub-electrode body 50 is protruded and extended outward so as to be curved or bent, the extended and protruded layer forms the electrode-constituting layer of the one sub-electrode body 50). Thus, the shared electrode-constituting layer 56 having a curved or folded form serves as the electrode-constituting layer of one sub-electrode body 50, and also serves as an electrode-constituting element of the other sub-electrode body 50 (particularly, the shared electrode-constituting layer 56 forms a continuously integrated layer in the electrode assembly 100). It is to be noted that, as can be seen from the illustrated form, the curved or folded portion of the shared electrode-constituting layer 56 is preferably positioned between one sub-electrode body 50 and the other sub-electrode body 50.

In the electrode assembly 100 of the present invention, “the wound portion 52” and “the non-wound portion 54” as the sub-electrode bodies 50 are composed of the electrode-constituting layer. That is, “the wound portion 52” and “the non-wound portion 54” each have a stacked configuration including a positive electrode, a negative electrode, and a separator between the positive electrode and the negative electrode. As can be seen from the forms shown in FIGS. 2 to 4, the wound portion 52 has a form in which electrode-constituting layers including a positive electrode, a negative electrode, and a separator between the positive electrode and the negative electrode are largely curved as a whole, (has a form of being curved in a roll or a form of being curved so as to be folded, as illustrated, meanwhile), meanwhile a non-wound portion 54 has a form in which electrode-constituting layers including a positive electrode, a negative electrode, and a separator between the positive electrode and the negative electrode are extended to each other in a planar shape. The wound portion 52 itself is preferably flat as a whole, and therefore it preferably has a form of being wound by folding. In other words, it can be said that the wound portion 52 is formed by folding the electrode-constituting layer at least once, meanwhile the non-wound portion 54 is not subjected to such folding.

The sub-electrode bodies may have equal thicknesses. Alternatively, the sub-electrode bodies may have different thicknesses. For example, in the embodiment shown in FIG. 2, the thickness of “the wound portion 52” is substantially the same as the thickness of “the non-wound portion 54”. In addition, the separation dimension between the sub-electrode bodies depends on the shared electrode-constituting layer, and may be, for example, a separation dimension in which the gap between the sub-electrode bodies is as small as possible, assuming that sub-electrode bodies are not bent. Although it is merely an example, it may be “a separation dimension between the sub-electrode bodies” such that the sub-electrode bodies are adjacent to each other side by side, assuming that sub-electrode bodies are not bent.

As can be seen from the forms shown in FIGS. 2 to 4, in the electrode assembly 100, the sub-electrode bodies 50, i.e., “the wound portion 52” and “the non-wound portion 54” or “the first wound portion 52A” and “the second wound portion 52B” or “the first non-wound portion 54A” and “the second non-wound portion 54B” are joined and connected to each other with the shared electrode-constituting layer 56 forming the bent portion interposed therebetween. Because of “sharing”, a joining portion 56 forms the electrode-constituting layer of one sub-electrode body and also forms the electrode-constituting layer of the other sub-electrode body. In other words, the electrode assembly 100 of the present invention has a configuration in which the electrode-constituting layer extending so as to project outward from one sub-electrode body is a constituent element of the other sub-electrode body, and vice versa. Particularly, in the present invention, the shared electrode-constituting layer 56 forms the bent portion of the electrode assembly, i.e., the bent portion as the secondary battery.

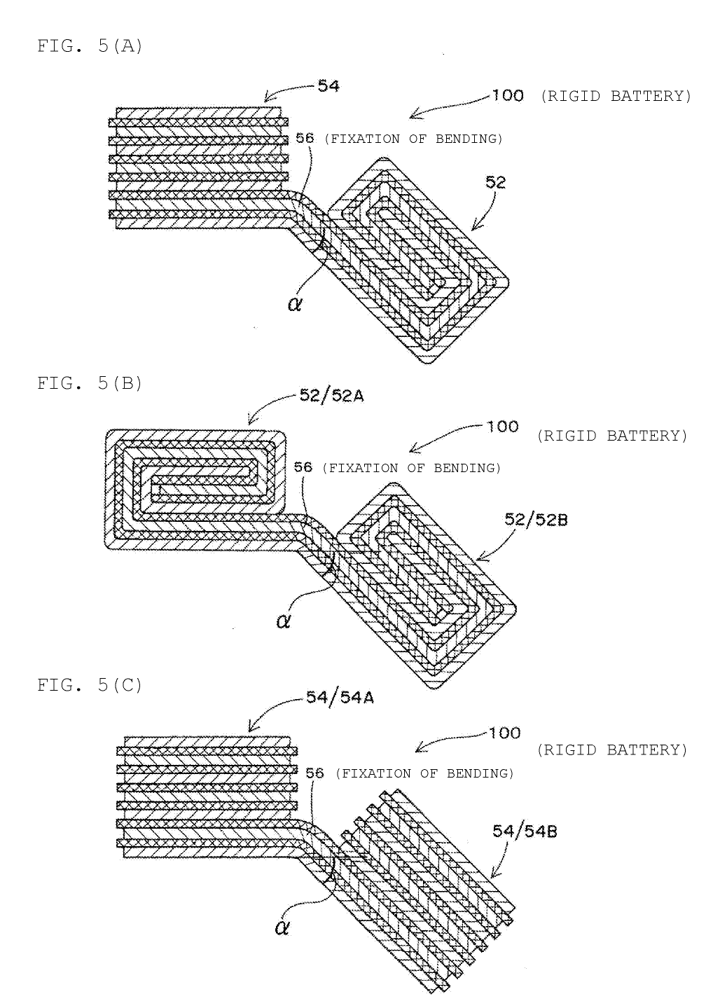

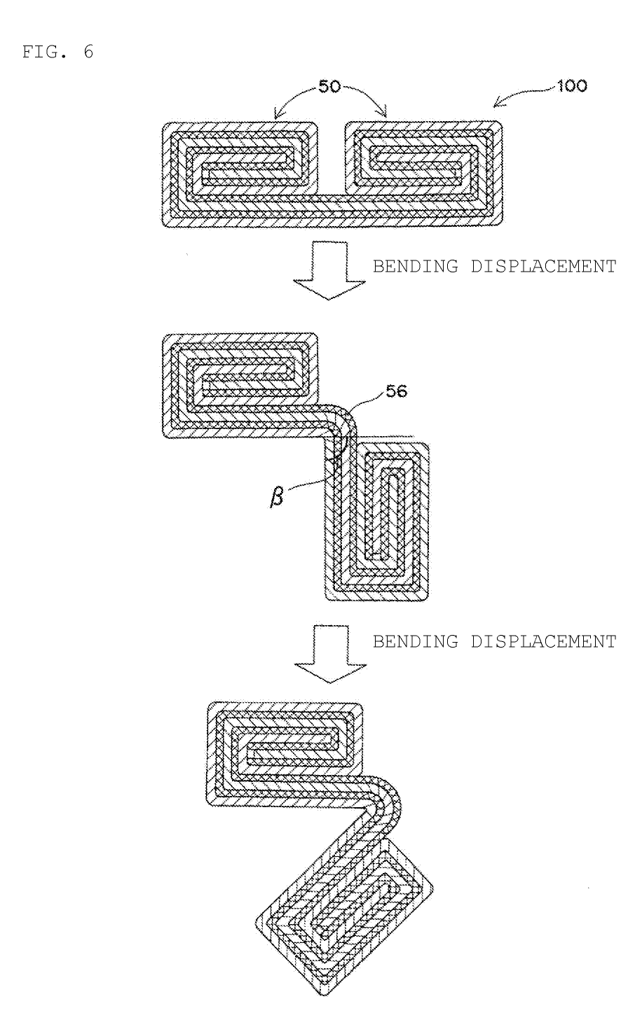

Here, the term “forming the bent portion” in the present invention means that the sub-electrode bodies are not positioned on the same plane due to the shared electrode-constituting layer 56 forming an angle, or means that the shared electrode-constituting layer 56 is displaced and deformed so as to form an angle, whereby the sub-electrode bodies are not positioned on the same plane. In the former case, the secondary battery of the present invention corresponds to “a rigid battery” (see FIGS. 5(A) to 5(C)), whereas in the latter case, the secondary battery of the present invention corresponds to “a flexible battery” (see FIG. 6). In other words, in the former case, the secondary battery of the present invention is the rigid battery which maintains the bent form at a bent portion 56, whereas in the latter case, the secondary battery of the present invention is the flexible battery which is bendable at the bent portion 56.

In the case of “the rigid battery”, as shown in FIGS. 5(A) to 5(C), a secondary battery 100 of the present invention is a battery in which a permanently bent form is not substantially changed, and particularly a battery which is not bent under normal use conditions or is not used after being bent. Therefore, even when the installation space of the battery does not have a simple rectangular parallelepiped shape, the rigid battery according to the present invention can be accommodated in the space. On the other hand, in the case of “the flexible battery”, as shown in FIG. 6, the secondary battery 100 of the present invention is a battery in which the bent form can be freely changed, and which can be bent, particularly by a user's normal force at the shared electrode-constituting layer 56 as a base point. Therefore, even when the installation space of the battery does not have a simple rectangular parallelepiped shape, the flexible battery according to the present invention can be accommodated in the space, and particularly can be flexibly accommodated depending on various shapes of the installation space. As described above, the secondary battery of the present invention has a higher degree of freedom in shape and can be suitably used also in applications where the installation space of the battery is more limited.

In the case of “the rigid battery”, the electrode assembly may have a bending angle of 90° or less between the sub-electrode bodies at the bent portion as a base point. In a preferred embodiment, the shared electrode-constituting layer forming the bent portion forms a bending angle of 90° or less. The electrode assembly 100 shown in FIG. 5(A) has a form in which the wound portion 52 and the non-wound portion 54 are joined in a bent state as a whole by the shared electrode-constituting layer 56 forming a bending angle of 90° or less. Similarly, the electrode assemblies 100 shown in FIGS. 5(B) and 5(C) have a form in which the wound portions (52A and 52B) are joined in a bent state as a whole by the shared electrode-constituting layer 56 forming a bending angle of 90° or less and a form in which the non-wound portions (54A and 54B) are joined in a bent state as a whole by the shared electrode-constituting layer 56 forming a bending angle of 90° or less, respectively. In either form, the shared electrode-constituting layer 56 is bent at an angle, whereby the electrode assembly 100 has a curved form as a whole. In the case of the shared electrode-constituting layer 56 bent at an angle, while suitably exhibiting application characteristics to the installation space in terms of battery shape (for example, suitably fitting to a curved device and an angular device), the bending angle is not relatively large and undesirable stress can be avoided, thereby realizing a highly safe battery.

The term “bending angle” in the present specification refers to an angle (an angle α in FIG. 5) formed by an extension line of the lower surface of one sub-electrode body (particularly, “an extension level obtained by extending the lower surface level of one sub-electrode body toward the other sub-electrode body”) and the lower surface of the other sub-electrode body in side view (sectional view) as shown in FIG. 5.

In the case of “the rigid battery”, “the bending angle α (see FIGS. 5(A) to 5(C)) between the sub-electrode bodies at the bent portion as a base point” is preferably 90° or less, and may be 80° or less, 70° or less or 60° or less, or may be 50° or less. The lower limit value of the bending angle α is not particularly limited, but is larger than 0°, and may be, for example, 5°, 10° or 15° because of the “bent portion”. Therefore, when the secondary battery of the present invention is the rigid battery, the bending angle α between the sub-electrode bodies at the bent portion as a base point is merely an example, but it may be 5° or more and 90° or less, 5° or more and 80° or less, 5° or more and 70° or less, 5° or more and 60° or less, 5° or more and 50° or less, 10° or more and 90° or less, 10° or more and 80° or less, 10° or more and 70° or less, 10° or more and 60° or less, or 10° or more and 50° or less, or may be 15° or more and 90° or less, 15° or more and 80° or less, 15° or more and 70° or less, 15° or more and 60° or less, or 15° or more and 50° or less.

On the other hand, in the case of “the flexible battery”, the electrode assembly 100 is preferably bendable so that the bending angle of the sub-electrode bodies is 180° or less at the bent portion as a base point. That is, in a preferred embodiment, the shared electrode-constituting layer forming the bent portion is bendably displaced at an angle of 180° or less, whereby the electrode assembly 100 can be bent as a whole. When a force is externally applied, as shown in FIG. 6, the shared electrode-constituting layer 56 which joins the sub-electrode bodies 50 is bent at an angle, and as a result, the sub-electrode bodies 50 are bendably displaced. In the case of the shared electrode-constituting layer 56 which is freely bent at an angle, there is an advantage that the application characteristics to the installation space are particularly high from the viewpoint of battery shape, and the battery shape can be more suitably changed in use, depending on various shapes of the installation space. A bending angle β (see FIG. 6) on a flexible substrate is more preferably less than 180°, and may be, for example, 135° or less, 90° or less, 45° or less, or 30° or less. The lower limit value of the bending angle β is not particularly limited, but it is larger than 0°, and is, for example, 5°, 10° or 15° because of the “bent portion”. Therefore, when the secondary battery of the present invention is the flexible battery, although the followings are merely examples, the bending angle β between the sub-electrode bodies at the bent portion as a base point may be 5° or more and less than 180°, 5° or more and 135° or less, 5° or more and 90° or less, 5° or more and 45° or less, or 5° or more and 30° or less, or may be 10° or more and less than 180°, 10° or more and 135° or less, 10° or more and 90° or less, 10° or more and 45° or less, or 10° or more and 30° or less, or may be 15° or more and less than 180°, 15° or more and 135° or less, 15° or more and 90° or less, 15° or more and 45° or less, 15° or more and 30° or less, or the like. It is to be noted that, when the sub-electrode bodies do not sterically interfere with each other, they can be bent in a direction opposite to the bending direction shown in FIG. 6, and thus the bending angle of the flexible battery is preferably ±180° or less (more preferably less than ±180°).

As described above, the electrode assembly according to the present invention has a form in which the sub-electrode bodies are not on the same plane due to “the electrode-constituting layer forming the bent portion” or can have such a form in which the sub-electrode bodies are not on the same plane. In the case of “the rigid battery”, one and the other of the sub-electrode bodies are permanently positioned on separate planes due to “the electrode-constituting layer forming the bent portion”. On the other hand, in the case of “the flexible battery”, the sub-electrode bodies are displaced appropriately so that one and the other of the sub-electrode bodies are positioned on separate planes due to “the electrode-constituting layer forming the bent portion” (i.e., it is a secondary battery that can be freely displaced and deformed).

In a preferred embodiment, the bent portion includes “a single” electrode-constituting layer. In other words, as shown in FIGS. 2 to 4, a plurality of shared electrode-constituting layers 56 forming a bent portion in the electrode assembly 100 is not provided (particularly, the provided form is not a form in which a plurality of the electrode-constituting layers is stacked), but only a shared electrode-constituting layer is provided. This means that, in one and the other of the sub-electrode bodies, “a joining portion forming a bent portion” is formed from an electrode-constituting layer 56. In other words, the joining portion forming the bent portion includes a positive electrode layer, a negative electrode layer, and a separator layer positioned therebetween, but does not include another positive electrode layer, another negative electrode layer, and another separator layer, which form a distinct electrode-constituting layer. It is to be noted that, in this preferred embodiment, as illustrated, when the distinct electrode-constituting layer is not formed, another separator layer may be included on such a single electrode-constituting layer.

In the case of “a single electrode-constituting layer”, “the bending” of the shared electrode-constituting layer is likely to be realized suitably. That is, one and the other of the sub-electrode bodies are easily positioned by separate planes, and the degree of freedom in shape of the secondary battery can be more suitably provided.

The secondary battery of the present invention can be embodied in various forms.

(Sub-Electrode Bodies Having Different Extending Lengths)

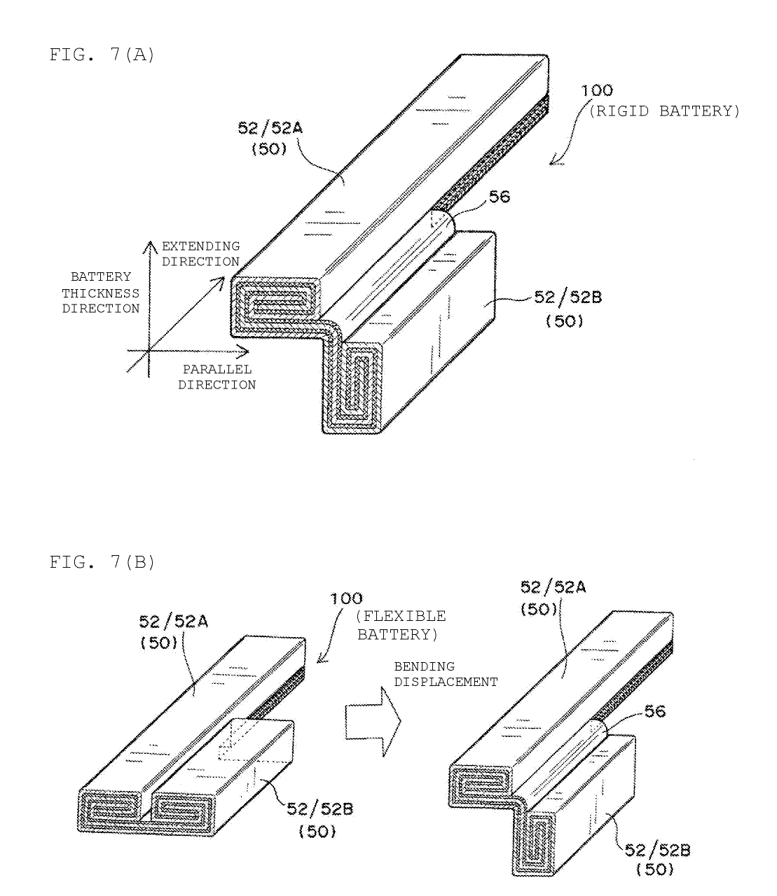

In the electrode assembly of the present invention, an extending length of one sub-electrode body and an extending length of the other sub-electrode body may be different from each other. Specifically, extending lengths of the sub-electrode bodies may be different from each other in a direction perpendicular to both a battery thickness direction and a direction parallel to the sub-electrode bodies. For example, in the case of the wound portions shown in FIG. 7, the lengths of “the wound portion 52A” and “the wound portion 52B” are different in a direction of the winding axis or the center axis (the axis of the winding center) of the wound portion 52. Thus, the shape of the electrode assembly in planar view, i.e., the shape of the secondary battery in planar view can be set to “a non-rectangular shape” or “an irregular shape”, thereby obtaining a secondary battery having a higher degree of freedom in shape. For example, it is possible to obtain a secondary battery that is suitable in terms of designability and/or effective utilization of space. In the form shown in FIG. 7 (B), it is a flexible battery having “a non-rectangular shape” (e.g., an L shape in planar view) like a square from which another small square is cut, and it is bendable by the shared electrode-constituting layer 56.

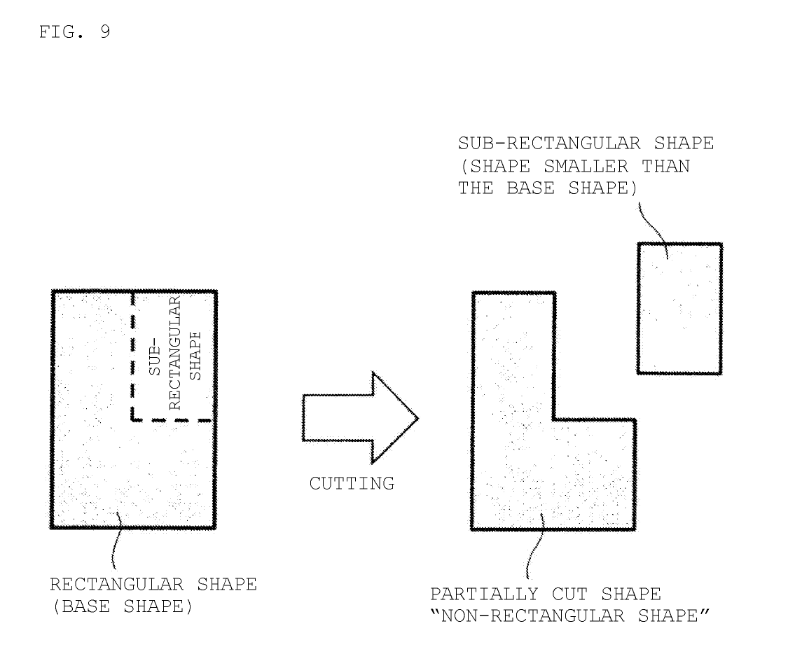

The term “non-rectangular shape” (or “irregular shape”) in the present specification means that the shape of the electrode assembly and the shape of the battery in planar view are not rectangular. The term “rectangular shape” used herein means a shape normally included in the concept of rectangular shapes such as a quadrate shape and an oblong shape in planar view. Therefore, the term “rectangular shape” indicates that a virtual cutout shape in planar view as viewed from the upper side in the thickness direction corresponds to a substantially quadrate shape or a substantially oblong shape. The term “non-rectangular shape” refers to a shape which is not normally included in the concept of rectangular shapes such as a quadrate shape and an oblong shape in planar view, and it refers particularly to a shape in which the quadrate shape or the oblong shape as the rectangular shape has a partially cut portion. Therefore, in a broad sense, the term “non-rectangular shape” refers to a shape in planar view as viewed from the upper side in the thickness direction, which is not quadrate or oblong. In a narrow sense, the term refers to a shape in planar view which is based on a quadrate shape or an oblong shape and has a partially cut portion therefrom (preferably a shape in which a corner portion of the quadrate shape or the oblong shape as a base is cut) (see FIG. 9). For example, “the non-rectangular shape” is a square or rectangular outline shape in planar view of the electrode assembly or the secondary battery in planar view, a square or rectangle having a size smaller than the base shape in a plan view size, a similar shape, or a shape obtained by cutting out a combination shape thereof from the base shape (particularly, a shape obtained by cutting out from the corner portion of the base shape).

(At Least Two Bent Portions)

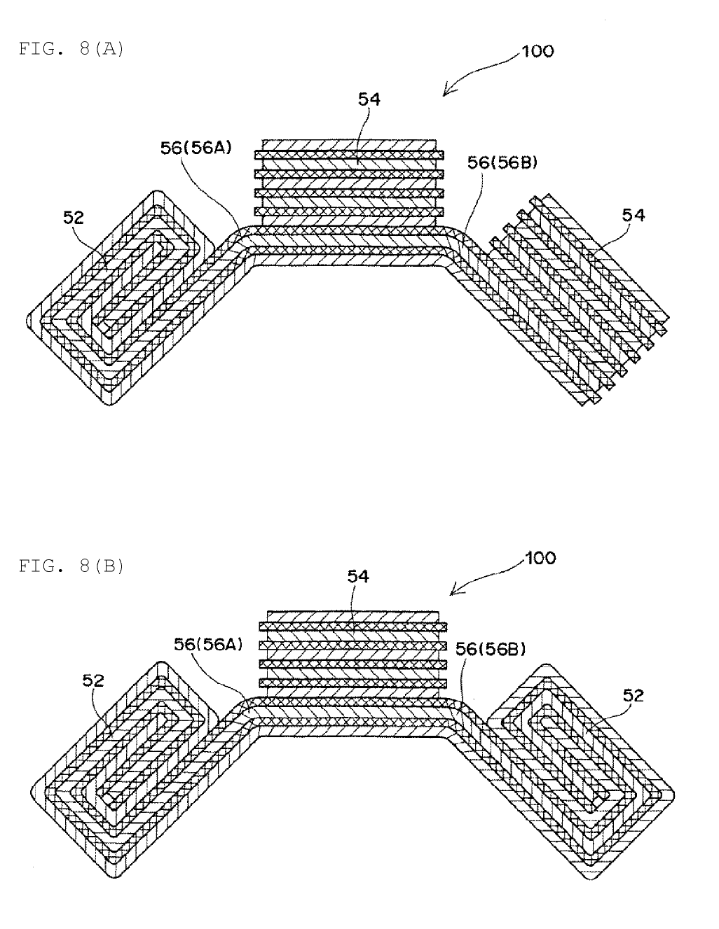

The electrode assembly in the present invention may have the form of at least “two bent portions”. Specifically, as shown in FIG. 8, the secondary battery of the present invention may have at least two bent portions. In other words, two or more shared electrode-constituting layers 56 forming the bent portions may be provided. Thus, a higher degree of freedom is provided to the three-dimensional shape of the electrode assembly 100. As illustrated, both a bent portion 56A and a bent portion 56B may have the form of a single electrode-constituting layer. In other words, the form may be the form in which each of the two bent portions 56A and 56B substantially includes a positive electrode layer and a negative electrode layer, and the bent portions include no positive and negative electrode layers other than the above positive and negative electrode layers. Similarly, as illustrated in the same figure, the shared electrode-constituting layers 56 forming the two bent portions may be common between the two bent portions 56A and 56B. In other words, the same shared electrode-constituting layers 56 may be in the form of extending longer and wider so as to form the two bent portions 56A and 56B.

(Modified Form of Bent Portion)

In the electrode assembly of the present invention, “the bent portion” may have various modified forms. For example, in the bent portion, at least one of the positive electrode and the negative electrode may not have “an electrode material layer including an electrode active material”. In other words, at least one of the positive electrode material layer and the negative electrode material layer may be removed from the bent portion which joins the sub-electrode bodies. This makes it easier to form “bending” more suitably, so that one sub-electrode body and the other sub-electrode body are easily positioned on separate planes. In such a case, a resin layer and/or tape material or the like may be provided for the bent portion from the viewpoint of increasing the structural strength or the like. For example, a resin layer containing a flexible resin material exhibiting elastomeric or rubber properties may be provided. Although the followings are merely examples, a material of resin such as a styrene resin, an olefin resin, a vinyl chloride resin, a polyester resin and/or a polyurethane resin may be used as a resin material exhibiting elastomeric properties.

(Form of Exterior Body)

An electrode assembly is accommodated in an exterior body, thereby constituting a secondary battery. The exterior body of the secondary battery of the present invention may be in the form of a hard case or in the form of a soft case. Specifically, the exterior body may be a hard case type corresponding to a so-called “metal can”, or may be a soft case type corresponding to a “pouch” made of a so-called laminate film. It is possible to use all the cases which are used as the exterior bodies in the field of secondary batteries. Although it is merely a typical form, a hard case type exterior body is preferred for “the rigid battery”, whereas a soft case type exterior body is preferred for “the flexible battery”.

Although the embodiments of the present invention have been described above, they are merely examples. Therefore, the present invention is not limited thereto, and those skilled in the art will readily understand that various forms can be conceived.

The secondary battery according to the present invention can be used in various fields in which electricity storage is expected. Although the followings are merely examples, the secondary battery can be used in electricity, information and communication fields where mobile devices are used (e.g., mobile device fields, such as mobile phones, smart phones, laptop computers, and digital cameras), domestic and small industrial applications (e.g., the fields such as electric tools, golf carts, domestic robots, caregiving robots, and industrial robots), large industrial applications (e.g., the fields such as forklifts, elevators, and harbor cranes), transportation system fields (e.g., the fields such as hybrid vehicles, electric vehicles, buses, trains, electric assisted bicycles, and two-wheeled electric vehicles), electric power system applications (e.g., the fields such as various power generation systems, load conditioners, smart grids, home-installation type power storage systems), and space and deep sea applications (e.g., the fields such as spacecraft and research submarines).

### DESCRIPTION OF REFERENCE SYMBOLS

50: Sub-electrode body
52: Wound portion
52A: First wound portion
52B: Second wound portion
54: Non-wound portion
54A: First non-wound portion
54B: Second non-wound portion
56: Shared electrode-constituting layer (joining portion)/bent portion
100: Electrode assembly

1. A secondary battery comprising:
a first electrode body, the first electrode body including a first electrode assembly having at least a first positive electrode, a first negative electrode, and a first separator between the first positive electrode and the first negative electrode;
a second electrode body, the second electrode body including a second electrode assembly having at least a second positive electrode, a second negative electrode, and a second separator between the second positive electrode and the second negative electrode; and
a bent portion, the bent portion including at least a third positive electrode joined to the first positive electrode and the second positive electrode, a third negative electrode joined to the first negative electrode and the second negative electrode, and a third separator between the third positive electrode and the third negative electrode and joined to the first separator and the second separator.

2. The secondary battery according to claim 1, wherein the first positive electrode, the first negative electrode, and the first separator of the first electrode body are in the shape of a wound body.

3. The secondary battery according to claim 2, wherein the second positive electrode, the second negative electrode, and the second separator of the second electrode body are in the shape of a stacked body.

4. The secondary battery according to claim 2, wherein the wound body is a first wound body, and the second positive electrode, the second negative electrode, and the second separator of the second electrode body are in the shape of a second wound body.

5. The secondary battery according to claim 1, wherein the first positive electrode, the first negative electrode, and the first separator of the first electrode body are in the shape of a stacked body.

6. The secondary battery according to claim 5, wherein the stacked body is a first stacked body, and the second positive electrode, the second negative electrode, and the second separator of the second electrode body are in the shape of a second stacked body.

7. The secondary battery according to claim 1, wherein the bent portion includes only one of the third positive electrode and only one of the third negative electrode.

8. The secondary battery according to claim 3, wherein the wound body and the stacked body are joined to each other by the bent portion.

9. The secondary battery according to claim 4, wherein the first wound body and the second wound body are joined to each other by the bent portion.

10. The secondary battery according to claim 6, wherein the first stacked body and the second stacked body are joined to each other by the bent portion.

11. The secondary battery according to claim 1, wherein the bent portion is flexible.

12. The secondary battery according to claim 11, wherein the bent portion is flexible such that a bending angle of 180° is formed between the first electrode body and the second electrode body as measured with the bent portion as a base point.

13. The secondary battery according to claim 1, wherein the bent portion is rigid and maintains a bent form at the bent portion.

14. The secondary battery according to claim 13, wherein a bending angle between the first electrode body and the second electrode body as measured with the bent portion as a base point is 90° or less.

15. The secondary battery according to claim 1, wherein a first extending length of the first electrode body is different from a second extending length of the second electrode body in a first direction perpendicular to a battery thickness direction and a second direction parallel to the first electrode body and the second electrode body.

16. The secondary battery according to claim 1, wherein the bent portion is a first bent portion, and the secondary battery further comprises:
a third electrode body, the third electrode body including a third electrode assembly having at least a fourth positive electrode, a fourth negative electrode, and a fourth separator between the fourth positive electrode and the fourth negative electrode; and
a second bent portion, the second bent portion including at least a fifth positive electrode joined to the first positive electrode and the fourth positive electrode, a fifth negative electrode joined to the first negative electrode and the fourth negative electrode, and a fifth separator between the fifth positive electrode and the fifth negative electrode and joined to the first separator and the fourth separator.

17. The secondary battery according to claim 16, wherein
the first positive electrode, the first negative electrode, and the first separator of the first electrode body are in the shape of a first stacked body,
the second positive electrode, the second negative electrode, and the second separator of the second electrode body are in the shape of a second stacked body, and
the fourth positive electrode, the fourth negative electrode, and the fourth separator of the third electrode body are in the shape of a wound body.

18. The secondary battery according to claim 16, wherein
the first positive electrode, the first negative electrode, and the first separator of the first electrode body are in the shape of a stacked body,
the second positive electrode, the second negative electrode, and the second separator of the second electrode body are in the shape of a first wound body, and
the fourth positive electrode, the fourth negative electrode, and the fourth separator of the third electrode body are in the shape of a second wound body.

19. The secondary battery according to claim 1, wherein the first, second, third, fourth and fifth positive electrodes and the first, second, third, fourth and fifth negative electrodes have a layer configured to occlude and release lithium ions.

20. The secondary battery according to claim 1, wherein the first, second and third positive electrodes and the first, second and third negative electrodes have a layer configured to occlude and release lithium ions.
